(19) United States
(12) Patent Application Publication
(10) Pub. No.: US 2018/0141156 A1
(43) Pub. Date: May 24, 2018

(54) SYSTEMS AND METHODS FOR WELDING

(71) Applicants: TOYOTA MOTOR EUROPE, Brussels (BE); TOYOTA JIDOSHA KABUSHIKI KAISHA, Toyota-shi, Aichi-ken (JP)

(72) Inventors: Akira TSUKUI, Woluwe-Saint-Lambert (BE); Takayuki NAKAYAMA, Nisshi-shi (JP)

(73) Assignees: TOYOTA MOTOR EUROPE, Brussels (BE); TOYOTA JIDOSHA KABUSHIKI KAISHA, Toyota-shi, Aichi-ken (JP)

(21) Appl. No.: 15/570,525

(22) PCT Filed: Jun. 26, 2015
(86) PCT No.: PCT/EP2015/064531

§ 371 Date: Oct. 30, 2017

(51) Int. Cl. B23K 26/20; B23K 26/08; H01M 2/04; H01M 2/36

(52) U.S. Cl. CPC B23K 26/206; B23K 26/0823; H01M 2/365; H01M 2/361; H01M 2/0404

(57) ABSTRACT

A laser welding system is provided. The laser welding system includes a laser source configured to produce a laser beam, a beam modifier configured to split the laser beam into at least two heat source points positioned at a predetermined angle relative to one another along a diagonal intersecting and radially equidistant from a center of a circular weld line, the circular weld line being concentric with an object to be welded, a rotation unit configured to cause rotation of the at least one group of two heat source points or the object to be welded, and a controller configured to control the rotation unit to cause the at least one group of two heat source points to scan substantially all of the circular weld line.

### FIELD OF THE DISCLOSURE

The present disclosure is related to systems and methods for welding, and more particularly to laser welding using optical elements to form multiple heat source points.

### BACKGROUND OF THE DISCLOSURE

In manufacturing of electronic devices, e.g., batteries, fuel cells, etc., component design often involves various pieces (e.g., two or more thin metal sheets) being assembled together by welding.

Typically, metal sheets are positioned together and placed on a welding support. A welding device (e.g., laser, electron beam/plasma, arc-welder, and/or other similar devices) can then be used to perform a welding operation.

For example, when closing a filling hole of a battery (e.g., a lithium-ion battery), the inner portion of the battery may be assembled or placed within the case, the cover welded in place, electrolyte provided via the filling hole, and an the filling hole in the battery case is then closed by laser welding a cap to cover the hole.

This laser welding operation is carried out using a single point laser that is scanned along the periphery of the cap, typically a circular periphery, and results in significant amounts of heat being transferred (e.g., via conduction) to the surrounding battery cover. The heat thus transferred can result in undesirable effects, such as, for example, vaporization of the electrolyte within the battery and pressurization of the battery contents. This in turn can cause a defective weld and future weld failure.

JP2013-127906 discloses a secondary battery having a container a heat input part, and a lid. The container has a wall part provided with an opening and houses an electrode body and an electrolytic solution. The heat input part comprises portions, provided on an outer surface of the wall surface along an edge of the opening and arranged in a direction that moves away from the opening, and is provided on the wall part. The lid is fixed to the wall part overlapping with the heat input part and closes the opening. The heat input part has first portions enclosing the opening and a second portion which encloses the opening at a position close to the edge compared to the first portions, the heat input being deeper than that of the first portion in the second portion.

JP2012-169254 discloses a secondary battery including a container having a pouring hole, through which an electrolyte is poured, and housing the electrolyte poured through the pouring hole, together with an electrode body, and a sealing lid fixed to the container and closing the pouring hole. The container has a plurality of grooves extending in parallel along the outer edge of the pouring hole, in a predetermined region around the pouring hole, and the sealing lid is provided on the plurality of grooves so as to close the pouring hole and is fixed to the container.

### SUMMARY OF THE DISCLOSURE

According to embodiments of the present disclosure, a laser welding system is provided. The laser welding system includes a laser source configured to produce a laser beam, beam modifying means configured to split the laser beam into at least two heat source points positioned at a predetermined angle relative to one another and radially equidistant from a center of a circular weld line, the circular weld line being concentric with an object to be welded, rotating means configured to cause rotation of the at least two heat source points or the object to be welded, and controlling means configured to control the rotating means to cause the at least two heat source points to scan substantially all of the circular weld line.

By providing such a configuration, the time that a welded part is irradiated by a laser can be substantially reduced, e.g., by up to 400 percent, and therefore, temperature increases in surrounding areas of the welded object due to prolonged heating can be significantly limited. By limiting such temperature increases, vaporization of an electrolyte inside a battery, for example, can be limited or even eliminated, thus preventing weld defects due to such effects.

The at least two heat source points may be positioned opposite one another along a diagonal intersecting the center of the circular weld line.

The predetermined angle may be 180 degrees.

The beam modifying means may be configured to split the laser beam to produce at least two groups of two heat source points, the two heat source points of a second of the at least two groups being offset by 90 degrees from the two heat source points of a first of the at least two groups.

The rotating means may be configured to rotate the at least one group of heat source points through at least 90 degrees but not more than 180 degrees.

The rotating means may be operably connected to the beam modifying means to cause rotation of the beam modifying means.

The rotating means may be configured to rotate the object to be welded through at least 90 degrees but not more than 180 degrees

The beam modifying means may include a diffractive optical element, for example, a diffractive grating.

The object to be welded may be an electrolyte fill-hole cap of a battery.

The at least one group of two heat source points may be transmitted to the object to be welded without being reflected by a mirror.

According to further aspects of the present disclosure, a method for laser welding is provided. The method includes splitting a laser beam into at least two heat source points, the at least two heat source points being positioned at a predetermined angle relative to one another and radially equidistant from a center of a circular weld line, the circular weld line being concentric with an object to be welded and rotating the at least two heat source points about the center of the circular weld line, or rotating the object to be welded such that the at least two heat source points scan substantially the entire circular weld line.

By providing such a method, the time that a welded part is irradiated by a laser can be substantially reduced, e.g., by up to 400 percent, and therefore, temperature increases in surrounding areas of the welded object due to prolonged heating can be significantly limited. By limiting such temperature increases, vaporization of an electrolyte inside a battery, for example, can be limited or even eliminated, thus preventing weld defects due to such effects.

The at least two heat source points may be positioned opposite one another along a diagonal intersecting the center of the circular weld line.

The splitting may result in at least two groups of two heat source points, the two heat source points of a second of the at least two groups being offset by 90 degrees from the two heat source points of a first group of the at least two groups.

The at least two heat source points or the object to be welded may be rotated through at least 90 degrees but not more than 180 degrees.

The splitting may include passing the laser beam through a diffractive optical element, for example a diffractive grating. The diffractive optical element may be rotated, for example, to cause rotation of the heat source points.

According to still further embodiments of the disclosure, an electrolyte fill-hole cap of a battery welded according to the above methods may be provided.

It is intended that combinations of the above-described elements and those within the specification may be made, except where otherwise contradictory.

It is to be understood that both the foregoing general description and the following detailed description are exemplary and explanatory only and are not restrictive of the disclosure, as claimed.

The accompanying drawings, which are incorporated in and constitute a part of this specification, illustrate embodiments of the disclosure and together with the description, serve to explain the principles thereof.

### BRIEF DESCRIPTION OF THE DRAWINGS

FIG. 1A shows a typical prior art welding profile;

FIG. 1B shows an exemplary target where welding may be performed;

FIG. 2 shows an exemplary welding system according to embodiments of the present disclosure;

FIG. 3 shows an exemplary welding profile according to embodiments of the present disclosure;

FIG. 4 shows rotation of an exemplary welding profile according to embodiments of the present disclosure; and

FIG. 5 shows an exemplary flow chart for welding according to embodiments of the present disclosure.

### DESCRIPTION OF THE EMBODIMENTS

Reference will now be made in detail to exemplary embodiments of the disclosure, examples of which are illustrated in the accompanying drawings. Wherever possible, the same reference numbers will be used throughout the drawings to refer to the same or like parts.

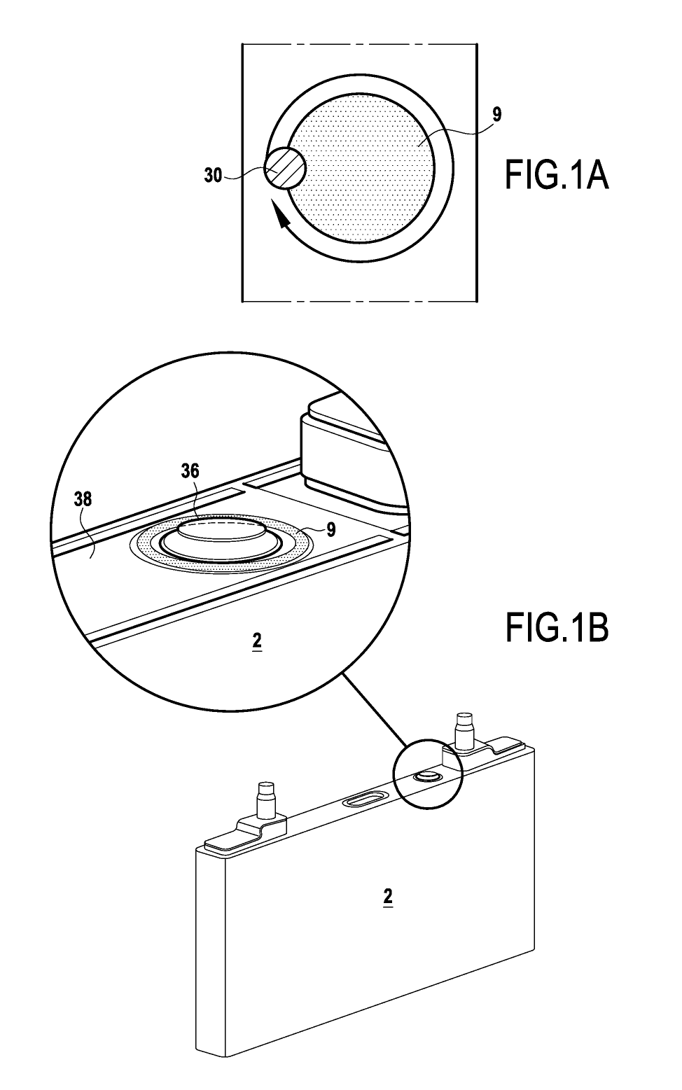

FIG. 1A shows a prior art welding technique for welding an electrolyte fill-hole cap 36 to a cover 38 of a battery as shown in FIG. 1B. As described above, a single point laser is used, and this single point is scanned around 360 degrees of the circumference of the part to be welded. During such welding, excess heat is transferred to the surrounding areas and electrolyte vaporization can occur.

When electrolyte vaporization occurs, internal pressure build up can cause significant weld defects. These defects can lead to later problems with the battery.

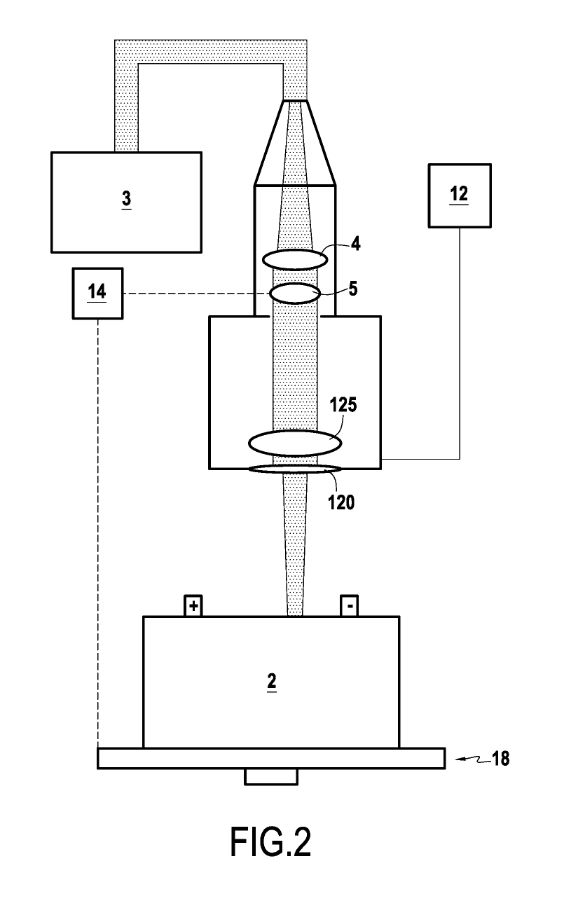

FIG. 2 shows an exemplary welding system 1 configured to remedy the above problems according to embodiments of the present disclosure. Welding system 1 may include a laser source 3, a collimator 4, beam modifier 5, a rotating unit 14, and a controller 12. One of skill in the art will understand that more or fewer components may be present without departing from the scope of the present disclosure (e.g., protective glass cover 120, focusing lens 125, etc.)

Laser source 3 includes any suitable device for providing a laser beam, for example, a laser oscillator. Laser source 3 may provide laser light at any wavelength and energy level suitable for welding materials associated with target 2. For example, suitable laser sources include, ruby lasers, Nd:YAG lasers, fiber lasers, gas lasers (helium, nitrogen, carbon dioxide), etc.

Collimator 4 may be optionally provided within welding system 1, and can be configured to collimate laser light provided by laser source 3. For example, laser light provided by laser source 3 may pass through a delivery medium (e.g., optical fiber) to arrive at a desired location. Upon exiting the delivery medium, the laser light may be collimated via collimator 4 to desirably align the light waves and narrow the beam before passing through additional optical elements, e.g., beam modifier 5. Collimator 4 may therefore be any lens, mirror, or other suitable element for collimating laser light.

Beam modifier 5 may comprise one or more optical elements capable of splitting a laser beam provided by laser source 3 into a desired number of output laser beams and/or shaping at least one group 60 of two heat source points 30 formed by the splitting into a desired profile. For example, beam modifier 5 may comprise one or more diffractive optical elements (e.g., diffractive gratings) fabricated to split an incident laser beam provided by laser source 3 into at least one group 60 of two heat source points 30, for example, an FBS—Gauss-to-Top Hat Focus Beam Shaper by TOPAG. One of skill in the art will recognize that this device is exemplary only.

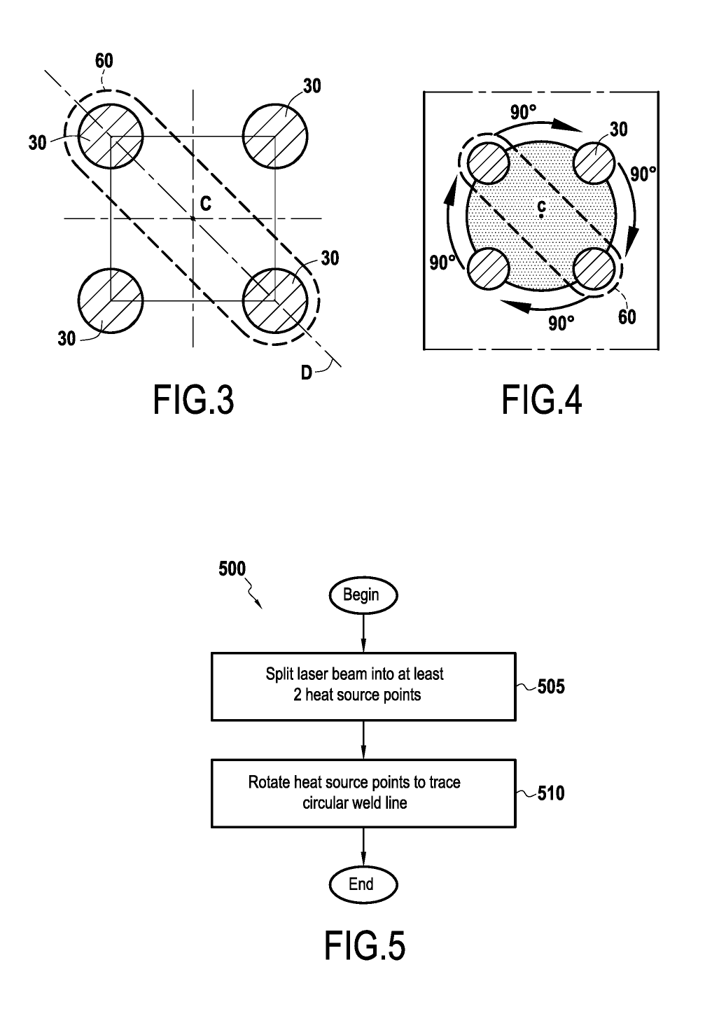

FIG. 3 shows an exemplary welding profile according to embodiments of the present disclosure. The two heat source points 30 of a group 60 may be positioned at a predetermined angle and radially equidistant from a center C of a circular weld line 9. For example, the two heat source points may be positioned opposite one another along a diagonal D, such diagonal D passing through the center C. In such a configuration, a separation of 180 degrees may be present between the two heat source points 30 of group 60 (i.e., the predetermined angle is 180 degrees).

According to some embodiments, at least two such groups 60 of two heat source points 30 (i.e., 4 total heat source points 30) may result from beam modifier 5, for example, presenting heat source points 30 at four corners of a square profile as shown at FIG. 3. In such a case, for example, 90 degrees of separation may be provided between a heat source point 30 of the first group 60 of heat source points, and a heat source point 30′ of the second group 60′ of heat source points. One of skill in the art will recognize that the present disclosure is not limited to two, four, or even six heat source points, and that any suitable configuration allowing rotation about a center C of the circular weld line 9 may be used.

Returning to FIG. 2, rotating unit 14 may be configured to cause heat source points 30 to rotate about the center C of circular weld line 9 in order to scan the weld line 9 to perform the welding operation. Therefore, rotating unit 14 may comprise any suitable device, or combination of devices such as motors, belts, chains, etc. configured to cooperatively cause the desired rotation.

For example, rotating unit 14 may communicate with a controller 12 and be linked with beam modifier 5 to permit rotation of heat source points 30 around weld line 9 of target 2.

Alternatively, or in addition, as one of skill in the art will recognize, rotating unit 14 may be configured to rotate target 2 such that heat source points 30 scan weld line 9, even where heat source points 30 remain static. In such an embodiment, target 2 may be mounted on, for example, a rotating platform 18 or other suitable support, and rotating unit 14 may rotate such support 18 to subject weld line 9 to irradiation by heat source points 30.

Importantly, while controller 12 is discussed as a separate component from rotating unit 14, one of skill in the art will recognize that controller 12 may be integrated with rotating unit 14 (i.e., a single structure) or may be provided separately from rotating unit 14. One of skill will further recognize that portions of controller 12 may be present with rotating unit 14 while other portions of controller 12 are implemented at a location remote from rotating unit 14.

FIG. 4 shows rotation of an exemplary welding profile according to embodiments of the present disclosure. Rotating unit 14 may be configured to rotate a group 60 of heat source points 30 through 180 degrees, for example. Such may be the case when a single group 60 of two heat source points 30 is provided. In another example, where two groups 60 of heat source points 30 are provided, rotating unit 14 may rotate each group 60 through 90 degrees, which may be sufficient for scanning weld line 9. One of skill will recognize that by limiting the rotation of the heat source points, a time period during which the target 2 is irradiated is reduced, thereby reducing the associated temperature increase of areas of target 2 surrounding weld line 9.

Controller 12 may comprise any suitable control device capable of generating and sending commands to rotating unit 14 to accomplish a desired welding task. For example, controller 12 may comprise a PIC based controller, a RISC based controller, etc. Controller 12 may further be configured to interface with one or more networks, e.g., LAN, WAN, Internet, etc. so as to receive instructions via the network.

In addition, rotating unit 14 may comprise one or more elements designed to perform its intended operation in an automated manner. For example, one or more servo motors (not shown) may be provided and configured to rotate, and/or otherwise manipulate beam modifier 5 so as to perform a desired rotation operation during welding. Controller 12 may be utilized to provide instructions to such elements in order to carry out such automation.

FIG. 5 is a block diagram 500 describing an exemplary method according to embodiments of the present disclosure. According to methods of the present disclosure, a laser beam from laser source 3 may be provided to beam modifier 3 and split into at least two heat source points (step 505). For example, where beam modifier comprises a diffractive optical element, the diffractive optical element may be configured to provide a first heat source point 30 at a first point on circular weld line 9 and a second heat source point at a second point on circular weld line 9, these two heat source points being positioned at a predetermined angle relative to one another and also being equidistant from a center of a circular weld line. For example, where a predetermined angle of 180 degrees is used, a diagonal D connecting these two points may be drawn, the diagonal D passing through the center C of the circular weld line 9.

Similarly, where a second group of two heat source points 30 is provided, 90 degrees may separate a heat source point of the first group and a heat source point of the second group. Further, a diagonal D connecting the two points of the second group may be drawn, the diagonal D passing through the center C of the circular weld line 9.

Controller 12 may then provide instructions causing rotation of the heat source points around the circular weld line 9 (step 710). For example, rotating element 14 may cause rotation of beam modifier 5 such that heat source points 30 rotate about center C to pass over weld line 9. Alternatively, controller 12 may provide instructions causing rotation element 14 to rotate target 2 such that heat source points 30 irradiate the circumference of weld line 9.

By providing such systems and methods, the time to complete the weld about weld line 9 may be reduced by 200 to 400 percent, thereby saving energy and money. In addition, waste heat that may accumulate in the areas surrounding weld line 9 of target 2 may be reduced because of the reduced heating time. This in turn reduces the risk of vaporization of the electrolyte inside of a battery.

One of skill in the art will recognize that variations may be made to structures and methods described herein. For example, while exemplary embodiments have been discussed using one or two heat source point groups, one of skill will recognize that three, four, or more heat source point groups could be implemented depending on a welding task.

Additionally, while in the drawings rotation by rotation unit 14 is shown as a clockwise rotation, one of skill in the art will recognize that a counterclockwise rotation could be implemented with equal efficacy.

Throughout the description, including the claims, the term “comprising a” should be understood as being synonymous with “comprising at least one” unless otherwise stated. In addition, any range set forth in the description, including the claims should be understood as including its end value(s) unless otherwise stated. Specific values for described elements should be understood to be within accepted manufacturing or industry tolerances known to one of skill in the art, and any use of the terms “substantially” and/or “approximately” and/or “generally” should be understood to mean falling within such accepted tolerances.

Where any standards of national, international, or other standards body are referenced (e.g., ISO, etc.), such references are intended to refer to the standard as defined by the national or international standards body as of the priority date of the present specification. Any subsequent substantive changes to such standards are not intended to modify the scope and/or definitions of the present disclosure and/or claims.

Although the present disclosure herein has been described with reference to particular embodiments, it is to be understood that these embodiments are merely illustrative of the principles and applications of the present disclosure.

It is intended that the specification and examples be considered as exemplary only, with a true scope of the disclosure being indicated by the following claims.

1. A laser welding system, comprising:
a laser source configured to produce a laser beam;
a beam modifier configured to split the laser beam into at least two heat source points positioned at a predetermined angle relative to one another and radially equidistant from a center of a circular weld line, the circular weld line being concentric with an object to be welded;
a rotation unit configured to cause rotation of the at least two heat source points or the object to be welded; and
a controller configured to control the rotating means to cause the at least two heat source points to scan substantially all of the circular weld line.

2. The laser welding system according to claim 1, wherein the at least two heat source points are positioned opposite one another along a diagonal intersecting the center of the circular weld line.

3. The laser welding system according to claim 1, wherein the predetermined angle is 180 degrees.

4. The laser welding system according to claim 1, wherein the beam modifier is configured to split the laser beam to produce at least two groups of two heat source points, the two heat source points of a second of the at least two groups being offset by 90 degrees from the two heat source points of a first of the at least two groups.

5. The laser welding system according to claim 1, wherein the rotation unit is configured to rotate the at least two heat source points through at least 90 degrees but not more than 180 degrees.

6. The laser welding system according to claim 1, wherein the rotation unit is operably connected to the beam modifier to cause rotation of the beam modifier.

7. The laser welding system according to claim 1, wherein the rotation unit is configured to rotate the object to be welded through at least 90 degrees but not more than 180 degrees.

8. The laser welding system according to claim 1, wherein the beam modifier comprises a diffractive optical element.

9. The laser welding system according to claim 1, wherein the object to be welded comprises an electrolyte fill-hole cap of a battery.

10. The laser welding system according to claim 1, wherein the at least one group of two heat source points is transmitted to the object to be welded without being reflected by a mirror.

11. A method for laser welding, comprising:
splitting a laser beam into at least two heat source points, the at least two heat source points being positioned at a predetermined angle relative to one another and radially equidistant from a center of a circular weld line, the circular weld line being concentric with an object to be welded; and
rotating the at least two heat source points about the center of the circular weld line, or rotating the object to be welded such that the at least two heat source points scan substantially the entire circular weld line.

12. The method according to claim 11, wherein the at least two heat source points are positioned opposite one another along a diagonal intersecting the center of the circular weld line.

13. The method according to claim 11, wherein the splitting results in at least two groups of two heat source points, the two heat source points of a second of the at least two groups being offset by 90 degrees from the two heat source points of a first group of the at least two groups.

14. The method according to claim 11, wherein the at least two heat source points or the object to be welded is rotated through at least 90 degrees but not more than 180 degrees.

15. The method according to claim 11, wherein the splitting comprises passing the laser beam through a diffractive optical element.

16. The method according to claim 15, comprising rotating the diffractive optical element.

17. An electrolyte fill-hole cap of a battery welded to a battery case according to the method of claim 11.

18. The laser welding system according to claim 8, wherein the diffractive optical element comprises a diffractive grating.

19. The method according to claim 15, where the diffractive optical element comprises a diffractive grating.
